(19) United States
(12) Patent Application Publication
(10) Pub. No.: US 2018/0293605 A1
(43) Pub. Date: Oct. 11, 2018

(54) SYSTEM FOR SHOPPING INCENTIVE DATA STORAGE AND RETRIEVAL

(71) Applicants: James Hooper, Hudson, NH (US); Suyhen Chan, Hudson, NH (US)

(72) Inventors: James Hooper, Hudson, NH (US); Suyhen Chan, Hudson, NH (US)

(21) Appl. No.: 15/480,585

(22) Filed: Apr. 6, 2017

(51) Int. Cl. G06Q 30/02

(52) U.S. Cl. CPC G06Q 30/0226

(57) ABSTRACT

A system for retrieval and storage of membership data that includes: a database accessible through a network; and a plurality shopping incentive membership data associated with each user, where the plurality shopping incentive membership data is stored in the database. The system also includes a software application adapted for storage onto a user's portable electronic device and an interactive interface available on a user's portable electronic device. The interactive interface enables a user to selectively retrieve shopping incentive membership data through functionality provided by the software application. Connectivity is provided through the network to sources of the shopping membership data. Data transfers occurs periodically between the database and sources updating specific membership data associated with each shopping incentive data. The system further includes a means to input shopping incentive membership data into the database.

### BACKGROUND OF THE INVENTION

### Field of Invention

The present invention relates to a system that stores multiple shopping incentive memberships and information for usage by a user.

### Description of Related Art

Mobile software applications are applications specifically designed for implementation on portable electronic devices such as smartphones and/or tablets. These mobile applications allow users with the means and access to information and functionality through the portable electric device. User interface is usually provided through a multitude of interactive screens and input/output options enable users to access data and to engage in various transactions through the portable electronic device. These computer interfaces allow for various shopping options and the inclusion of information related to shopping such as discounts, advertisement and payment options for the user. These applications are usually distributed through an application center that provides has connectivity for the end user. The applications allow users to usually store data and interface with the applications in association with various third-parties such as retailers, insurance companies, restaurants and a myriad of third-party interface opportunities.

Many marketers and retailers engage in shopping incentive memberships. Through these incentive memberships, users usually accumulate award points through a membership with a retailer. These points may accumulate and provide further discounts for the end-user through repeated use commonly known as loyalty points. Further retailers use these systems to award frequent shoppers with rewards in the form of incentive sales and award incentives due to accumulated point totals. One drawback to these systems relates to the common use of a membership card that the user normally produces at the time of purchase. Therefore, a frequent shopper must maintain various multiple membership cards while shopping at multiple stores. As a result, it would be advantageous to have a mobile application that could be used to manage multiple shopping incentive memberships through one convenient portable or mobile application. This information may be linked to a central database and then shared upon transactions.

### SUMMARY OF THE INVENTION

The present invention relates to a system for retrieval and storage of membership data that includes: a database accessible through a network; and a plurality shopping incentive membership data associated with each user, where the plurality shopping incentive membership data is stored in the database. The system also includes a software application adapted for storage onto a user's portable electronic device and an interactive interface available on a user's portable electronic device. The interactive interface enables a user to selectively retrieve shopping incentive membership data through functionality provided by the software application. Connectivity is provided through the network to sources of the shopping membership data. Data transfers occurs periodically between the database and sources updating specific membership data associated with each shopping incentive data. The system further includes a means to input shopping incentive membership data into the database.

### DETAILED DESCRIPTION

The present invention relates to a mobile software application for implementation on a portable electronic device such as a smartphone and/or a tablet. The present invention relates to storage and interfacing availability of shopping incentive memberships through a central mobile application. The present application enables users to store shopping incentive membership data in a central database linked through the mobile software application. The database stores a plurality of shopping incentive memberships associated with an end-user. The end-user is provided with a user interface for input of retail incentive memberships into the central database. The input of the user information includes membership information such as member number, point accumulation, award information and linkage with the retailer who may provide sales notices and incentives. The software application manages the end-user's membership info and retailers provide ready access to point accumulations, award information, sales and sales pricing that would be associated with each respective membership.

In one particular embodiment, a card reader may be used that connects to a portable electronic device and allows a user to simply swipe a retail membership card for input into the shopping incentive software database. Further it is contemplated that an award system is associated with each membership, where information and data associated with each membership is input into the database.

A link between the retailer and the application shopping database is handled within the back end of the application. As such this data linkage may be managed through a central processing unit associated with the mobile software application. A user may gain access to various stored membership information as needed through a portable electronic device. Through the portable electronic device and user interface, the user is able to retrieve a retail membership data associated with a particular retailer that is linked through the mobile software application.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A system for retrieval and storage of membership data comprising:
a. a database accessible through a network;
b. a plurality shopping incentive membership data associated with each user, where the plurality shopping incentive membership data is stored in the database;
c. a software application adapted for storage onto a user's portable electronic device;
d. an interactive interface available on a user's portable electronic device, where the interactive interface enables a user to selectively retrieve shopping incentive membership data through functionality provided by the software application.

2. The system according to claim 1, further including connectivity through the network to sources of the shopping membership data.

3. The system according to claim 2, further including data transfers between the database and sources updating specific membership data associated with each shopping incentive data.

4. The system according to claim 1, further including a means to input shopping incentive membership data into the database.

5. The system according to claim 1, where the means to input shopping incentive membership data includes a card reader adapted to connect to a user's portable electronic device.

6. The system according to claim 1, where the means to input shopping incentive membership data includes a graphical interface available on the user's portable electronic device.
